(19) United States
(12) Patent Application Publication
(10) Pub. No.: US 2021/0302016 A1
(43) Pub. Date: Sep. 30, 2021

(54) Blender

(71) Applicant: Yun Pan, Shenzhen (CN)

(72) Inventor: Yun Pan, Shenzhen (CN)

(21) Appl. No.: 16/835,261

(22) Filed: Mar. 30, 2020

(51) Int. Cl. F21V 33/00; A47J 43/046

(52) U.S. Cl. CPC F21V 33/0036; F21Y 2115/10; A47J 43/046

(57) ABSTRACT

A blender comprises a stirring cup and a light-emitting assembly which includes a battery, a lamp panel, and two spaced conductive parts, wherein each conductive part has one end electrically connected to the lamp panel and the other end stretching into the stirring cup, and the battery is electrically connected to the lamp panel. Liquids such as water, fruit juices, and liquor make contact with the two conductive parts after being added to the stirring cup, a conduction circuit is formed by the two conductive parts and the lamp panel through the liquids in the stirring cup, and then, the lamp panel lights up. The blender of the invention can automatically light up when used by users, thus having good user experience and increasing the pleasure in use.

### TECHNICAL FIELD

The invention relates to the technical field of kitchen appliances, in particular to a blender.

### DESCRIPTION OF RELATED ART

Blenders are appliances used to uniformly mix liquid and gaseous media by forced convection. Existing blenders only having a stirring function are bland when used to make drinks such as fruit juices and milk shakes, thereby having poor user experience.

### BRIEF SUMMARY OF THE INVENTION

The technical issue to be settled by the invention is to provide a blender which can light up after a liquid is added, thus having good user experience.

The technical solution adopted by the invention to settle the above-mentioned technical issue is as follows:

A blender comprises a stirring cup and a light-emitting assembly which includes a battery, a lamp panel, and two spaced conductive parts, wherein each conductive part has one end electrically connected to the lamp panel and the other end stretching into the stirring cup, and the battery is electrically connected to the lamp panel.

Furthermore, the light-emitting assembly further includes a light shielding part, and one end of each conductive part penetrates through the light shielding part to be electrically connected to the lamp panel.

Furthermore, the lamp panel includes a PCB and a lamp bead arranged on the PCB, and a light outlet is formed in the light shielding part and corresponds to the lamp bead.

Furthermore, the light-emitting assembly further includes a battery cover which is formed with a receiving space for receiving the battery and is detachably connected to the stirring cup.

Furthermore, a sealing ring is arranged between the battery cover and the stirring cup.

Furthermore, the blender further comprises a cutter assembly including a cutter and a cutter holder, wherein the cutter is fixedly arranged on the cutter holder and stretches into the stirring cup, and the cutter holder is detachably connected to an end, away from the light-emitting assembly, of the stirring cup.

Furthermore, the blender further comprises a drive assembly for driving the cutter to rotate.

The invention has the following beneficial effects: liquids such as water, fruit juices, and liquor make contact with the two conductive parts after being added to the stirring cup, a conduction circuit is formed by the two conductive parts and the lamp panel through the liquids in the stirring cup, and then, the lamp panel lights up; and the blender of the invention can automatically light up when used by users, thus having good user experience and increasing the pleasure in use.

### BRIEF DESCRIPTION OF THE SEVERAL VIEWS OF THE DRAWINGS

FIG. 1 is a structural exploded view of a blender in Embodiment 1 of the invention.

### REFERENCE SIGNS

1, stirring cup; 2, cutter assembly; 21, cutter; 22, cutter holder; 3, drive assembly; 41, battery; 42, lamp panel; 43, conductive part; 44, light shielding part; 45, battery cover; 46, sealing ring.

### DETAILED DESCRIPTION OF THE INVENTION

The technical contents, purposes, and effects of the invention are expounded below in combination with the embodiments and accompanying drawings.

The key conception of the invention lies in that two conductive parts stretch into a stirring cup and form a conduction circuit together with a lamp panel through liquids such as water, fruit juices, and liquor added into the stirring cup and making contact with the two conductive parts to turn on the lamp panel.

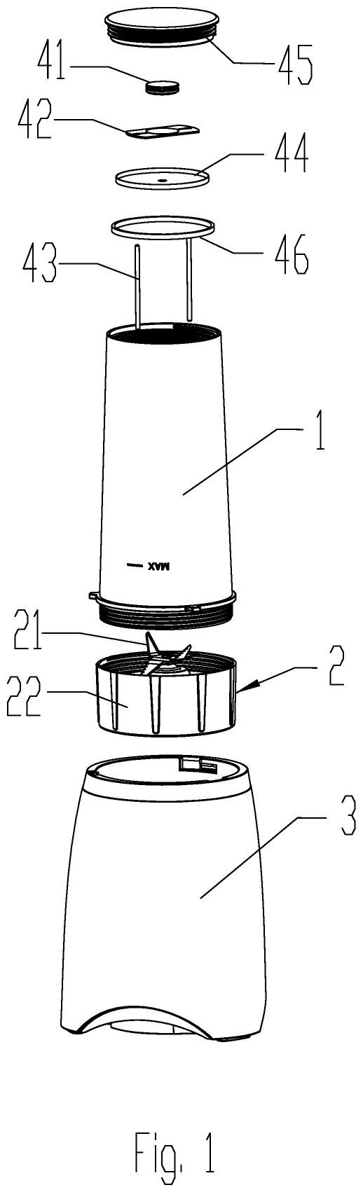

Referring to FIG. 1, a blender comprises a stirring cup 1 and a light-emitting assembly which includes a battery 41, a lamp panel 42, and two spaced conductive parts 43, wherein each conductive part 43 has one end electrically connected to the lamp panel 42 and the other end stretching into the stirring cup 1, and the battery 41 is electrically connected to the lamp panel 42.

From the above description, the invention has the following beneficial effects: liquids such as water, fruit juices, and liquor make contact with the two conductive parts after being added to the stirring cup, and a conduction circuit is formed by the two conductive parts and the lamp panel through the liquids in the stirring cup, and then, the lamp panel lights up; and the blender of the invention can automatically light up when used by users, thus having good user experience and increasing the pleasure in use.

Furthermore, the light-emitting assembly further includes a light shielding part 44, and one end of each conductive part 43 penetrates through the light shielding part 44 to be electrically connected to the lamp panel 42.

Furthermore, the lamp panel includes a PCB and a lamp bead arranged on the PCB, and a light outlet is formed in the light shielding part 44 and corresponds to the lamp bead.

From the above description, the light shielding part is configured to make sure that light emitted by the lamp bead shines out only via the light outlet.

Furthermore, the light-emitting assembly further includes a battery cover 45 which is formed with a receiving space for receiving the battery 41 and is detachably connected to the stirring cup 1.

From the above description, the battery cover is detachable, thus facilitating the replacement of the battery.

Furthermore, a sealing ring 46 is arranged between the battery cover 45 and the stirring cup 1.

From the above description, the sealing ring is configured to prevent water vapors against entry.

Furthermore, the blender further comprises a cutter assembly 2 including a cutter 21 and a cutter holder 22, wherein the cutter 21 is fixedly arranged on the cutter holder 22 and stretches into the stirring cup 1, and the cutter holder 22 is detachably connected to an end, away from the light-emitting assembly, of the stirring cup 1.

Furthermore, the blender further comprises a drive assembly 3 for driving the cutter 21 to rotate.

From the above description, the drive assembly may include a drive motor.

Referring to FIG. 1, Embodiment 1 of the invention is as follows:

Referring to FIG. 1, a blender comprises a stirring cup 1, a light-emitting assembly, a cutter assembly 2, and a drive assembly 3, wherein the light-emitting assembly is arranged at one end of the stirring cup 1, and the cutter assembly 2 is arranged at the other end of the stirring cup 1; the cutter assembly 2 includes a cutter 21 and a cutter holder 22, wherein the cutter 21 is fixedly arranged on the cutter holder 22 and stretches into the stirring cup 1, and the cutter holder 22 is detachably connected to one end of the stirring cup 1; and the drive assembly 3 drives the cutter 21 to rotate through a drive motor.

The light-emitting assembly includes a battery 41, a lamp panel 42, and two spaced conductive parts 43, wherein each conductive part 43 has one end electrically connected to the lamp panel 42 and the other end stretching into the stirring cup 1, and the battery 41 is electrically connected to the lamp panel 42. The light-emitting assembly further includes a light shielding part 44, and one end of each conductive part 43 penetrates through the light shielding part 44 to be electrically connected to the lamp panel 42. The lamp panel 42 includes a PCB and a lamp bead arranged on the PCB, and a light outlet is formed in the light shielding part 44 and corresponds to the lamp bead. The light-emitting assembly further includes a battery cover 45 which is formed with a receiving space for receiving the battery and is detachably connected to the stirring cup 1. Preferably, the battery cover 45 is detachably connected to the stirring cup 1 in a threaded manner. The sealing ring 46 is arranged between the battery cover 45 and the stirring cup 1 to prevent water vapors against entry and is made from silicon rubber or the like.

In this embodiment, liquids such as water, fruit juices, and liquor make contact with the two conductive parts 43 after being added to the stirring cup, a conduction circuit is formed by the two conductive parts 43 and the lamp panel 42 through the liquids in the stirring cup 1, and then, the lamp bead on the lamp panel 42 lights up.

In conclusion, the blender of the invention can automatically light up when used by users, thus having good user experience and increasing the pleasure in use.

The above embodiments are only illustrative ones of the invention, and are not intended to limit the patent scope of the invention. All equivalent transformations obtained on the basis of the contents in the specification and the accompanying drawings of the invention, or direct or indirect applications to related technical fields should also fall within the patent protection scope of the invention.

What is claimed is:

1. A blender, comprising a stirring cup and a light-emitting assembly which includes a battery, a lamp panel, and two spaced conductive parts, wherein each said conductive part has an end electrically connected to the lamp panel and an end stretching into the stirring cup, and the battery is electrically connected to the lamp panel.

2. The blender according to claim 1, wherein the light-emitting assembly further includes a light shielding part, and one end of each said conductive part penetrates through the light shielding part to be electrically connected to the lamp panel.

3. The blender according to claim 2, wherein the lamp panel includes a PCB and a lamp bead arranged on the PCB, and a light outlet is formed in the light shielding part and corresponds to the lamp bead.

4. The blender according to claim 1, wherein the light-emitting assembly further includes a battery cover which is formed with a receiving space for receiving the battery and is detachably connected to the stirring cup.

5. The blender according to claim 4, wherein a sealing ring is arranged between the battery cover and the stirring cup.

6. The blender according to claim 1, wherein the blender further comprises a cutter assembly including a cutter and a cutter holder, wherein the cutter is fixedly arranged on the cutter holder and stretches into the stirring cup, and the cutter holder is detachably connected to an end, away from the light-emitting assembly, of the stirring cup.

7. The blender according to claim 6, wherein the blender further comprises a drive assembly for driving the cutter to rotate.
